(19) United States
(12) Patent Application Publication
(10) Pub. No.: US 2024/0219524 A1
(43) Pub. Date: Jul. 4, 2024

(54) OPTICAL MODULE

(71) Applicant: Advanced Semiconductor Engineering, Inc., Kaohsiung (TW)

(72) Inventor: Hsin-Ying HO, Kaohsiung (TW)

(73) Assignee: Advanced Semiconductor Engineering, Inc., Kaohsiung (TW)

(21) Appl. No.: 18/092,148

(22) Filed: Dec. 30, 2022

(51) Int. Cl. G01S 7/481; G01S 17/08

(52) U.S. Cl. CPC G01S 7/4811; G01S 17/08

(57) ABSTRACT

An optical module is disclosed. The optical module includes an emitter, a receiver, and a pre-formed transparent element disposed over the emitter and the receiver. The pre-formed transparent element is configured to provide an optical guiding path within the optical module.

### BACKGROUND

### 1. Field of the Disclosure

The present disclosure relates to an optical module.

### 2. Description of the Related Art

In an optical module, a lid may be used to define an aperture for light transmission/reception and exclude unwanted optical noise or interference. The lid may occupy a certain surface area and a glass may be needed, which may be disadvantageous to achieving size reduction. It may be desirable to develop a smaller and cheaper optical module suitable for mass production.

### SUMMARY

In some arrangements, an optical module includes an emitter, a receiver, and a pre-formed transparent element disposed over the emitter and the receiver. The pre-formed transparent element is configured to provide an optical guiding path within the optical module.

In some arrangements, an optical module includes an electronic component, a first transparent element disposed over the electronic component, and a light blocking layer disposed over and conform to the first transparent element. A roughness of a top surface of the light blocking layer is greater than a roughness of another surface of the light blocking layer.

In some arrangements, an optical module includes an optical component, a transparent element disposed over the optical component, and an adhesive material disposed between the optical component and the transparent element. The adhesive material is transparent to a light emitting from or receiving by the optical component.

### BRIEF DESCRIPTION OF THE DRAWINGS

Aspects of some arrangements of the present disclosure are readily understood from the following detailed description when read with the accompanying figures. It is noted that various structures may not be drawn to scale, and dimensions of the various structures may be arbitrarily increased or reduced for clarity of discussion.

FIG. 1A is a cross-section of an exemplary optical module according to some arrangements of the present disclosure.

FIG. 1B is a cross-section of an exemplary optical module according to some arrangements of the present disclosure.

FIG. 1C is a cross-section of an exemplary optical module according to some arrangements of the present disclosure.

FIG. 1D is a perspective view of an exemplary optical module according to some arrangements of the present disclosure.

FIG. 1E is a top view of an exemplary optical module according to some arrangements of the present disclosure.

FIG. 2A is a cross-section of an exemplary optical module according to some arrangements of the present disclosure.

FIG. 2B is a cross-section of an exemplary optical module according to some arrangements of the present disclosure.

FIG. 3 is a cross-section of an exemplary optical module according to some arrangements of the present disclosure.

FIG. 4A is a cross-section of an exemplary optical module according to some arrangements of the present disclosure.

FIG. 4B is an enlarged view of an exemplary optical module according to some arrangements of the present disclosure.

FIG. 4C is a perspective view of an exemplary optical module according to some arrangements of the present disclosure.

FIG. 5 is a cross-section of an exemplary optical module according to some arrangements of the present disclosure.

FIGS. 6A, 6B, 6C, 6D, 6E, and 6F are cross-sections of one or more stages of a method of manufacturing an optical module in accordance with an arrangement of the present disclosure.

FIGS. 7A, 7B, 7C, 7D, and 7E are cross-sections of one or more stages of a method of manufacturing an optical module in accordance with an arrangement of the present disclosure.

### DETAILED DESCRIPTION

Common reference numerals are used throughout the drawings and the detailed description to indicate the same or similar components. Arrangements of the present disclosure will be readily understood from the following detailed description taken in conjunction with the accompanying drawings.

The following disclosure provides many different arrangements, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include arrangements in which the first and second features are formed or disposed in direct contact, and may also include arrangements in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various arrangements and/or configurations discussed.

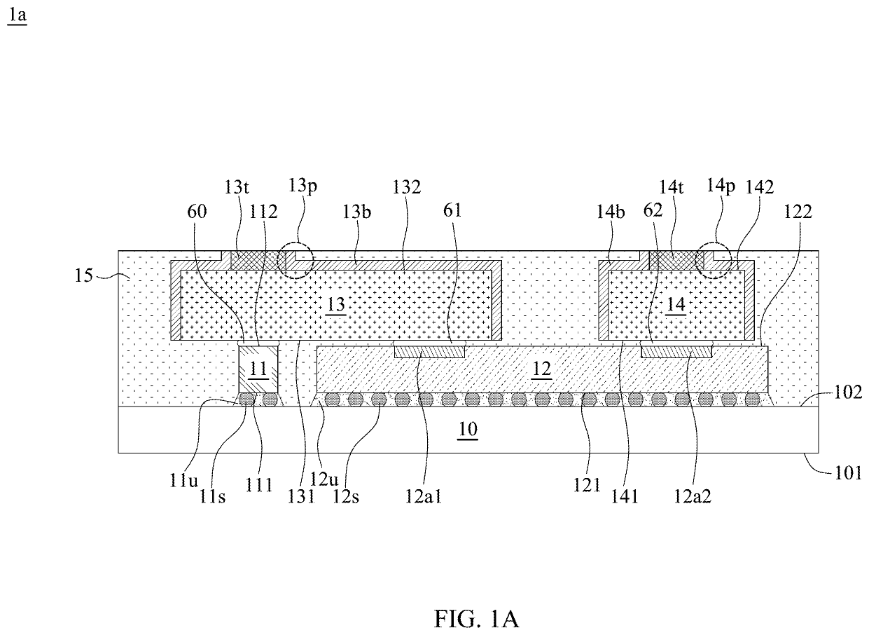

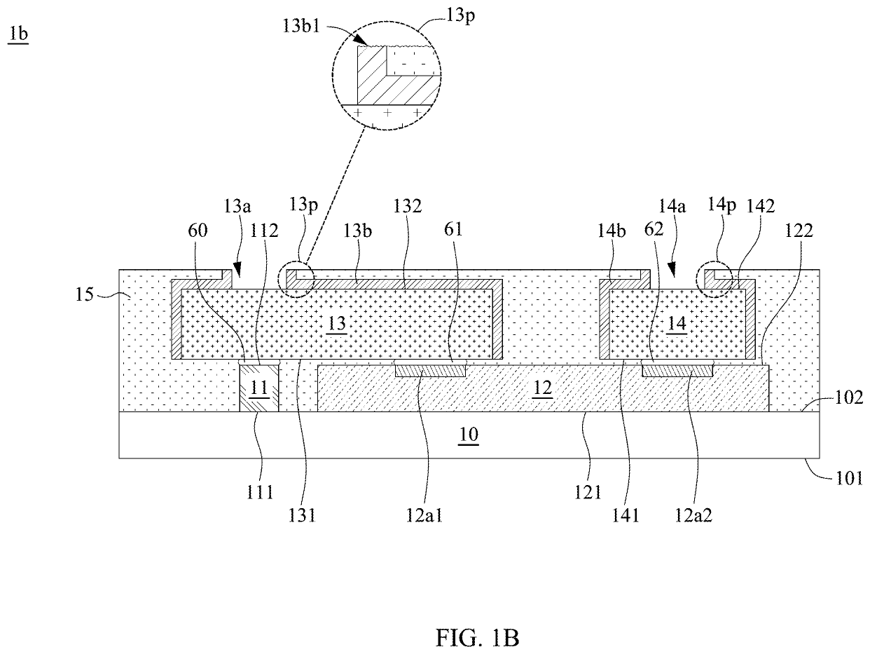

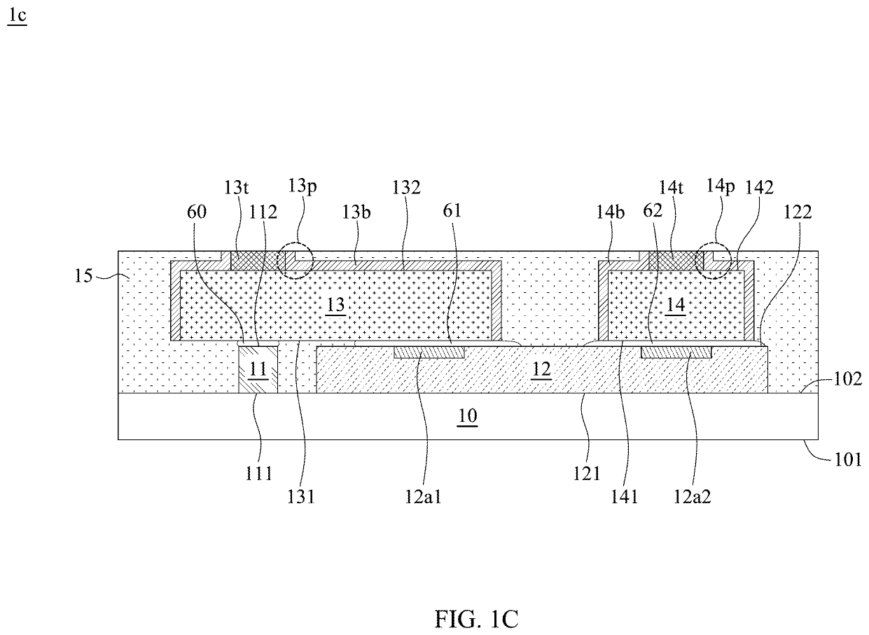

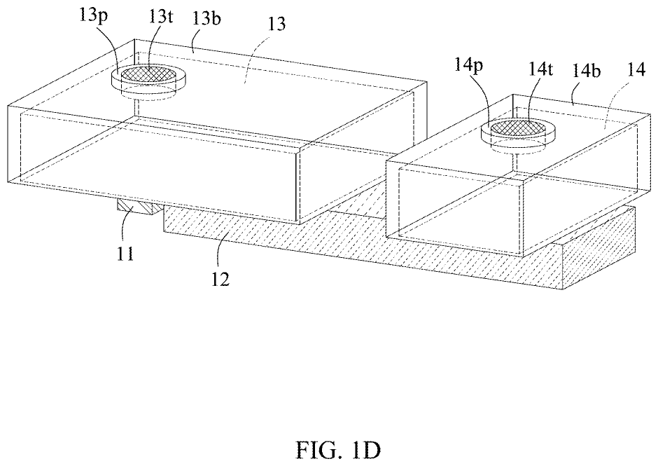

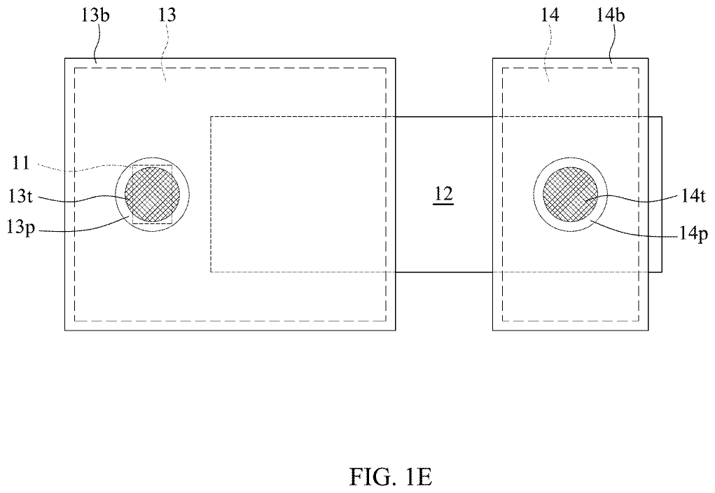

FIG. 1A is a cross-section of an exemplary optical module 1a according to some arrangements of the present disclosure. The optical module 1a may include a carrier 10, electronic devices 11, 12, optical components 13, 14, and an encapsulant 15.

The carrier 10 may include a printed circuit board (PCB), such as a paper-based copper foil laminate, a composite copper foil laminate, or a polymer-impregnated glass-fiber-based copper foil laminate. In some arrangements, the carrier 10 may include an interconnection structure, such as a redistribution layer (RDL), a conductive trace, a conductive via, a grounding element, etc. In some arrangements, the carrier 10 includes a ceramic material or a metal material. In some arrangements, the carrier 10 may include a substrate or a lead frame.

The carrier 10 may include a surface 101 and a surface 102 opposite to the surface 101. The carrier 10 may include one or more conductive pads (not shown) in proximity to, adjacent to, or embedded in and exposed by the surface 101 and/or the surface 102. The carrier 10 may include a solder resist (not shown) on the surface 101 and/or the surface 102 to fully expose or expose at least a portion of the conductive pads for electrical connections. The carrier 10 may support the electronic devices 11 and 12. The carrier 10 may electrically communicate with the electronic devices 11 and 12.

The electronic device 11 may be disposed over or on the surface 102 of the carrier 10. The electronic device 11 may be electrically connected to the carrier 10 through solder bonding, Cu-to-Cu bonding, wire bonding, or hybrid bonding. For example, the electronic device 11 may be electrically connected to the carrier 10 through an electrical contact 11s. In some arrangements, the electrical contacts 11s may include solder balls or solder bumps, such as a controlled collapse chip connection (C4) bump, a ball grid array (BGA) or a land grid array (LGA). In some arrangements, the electrical contacts 11s may be covered by an underfill 11u.

The electronic device 11 (or electronic component) may include an optical component, such as an emitter. The electronic device 11 may include a light emitting diode (LED), a laser diode (such as vertical cavity surface-emitting laser (VCSEL)), a lamp, a laser, any other suitable light source, or a combination thereof. The electronic device 11 may be configured to generate light or electromagnetic (EM) radiation in the ultraviolet, visible, and/or infrared spectral regions.

For example, the electronic device 11 may include a light source that emits visible light of one or more wavelengths (or frequencies, or bandwidths), such as red, blue, and green light. For example, the electronic device 11 may include a light source that emits invisible light of one or more wavelengths (or frequencies, or bandwidths), such as infrared light. The electronic device 11 may include any number of light sources, such as an array of pixels.

The electronic device 11 may include a surface 111 facing the carrier 10 and a surface 112 opposite to the surface 111 and facing away from the carrier 10. The surface 112 of the electronic device 11 may include an active surface, an active region, or a light emitting region. Light may be emitted from the surface 112 of the electronic device 11. The surface 111 of the electronic device 11 may include a backside surface or a rear surface. In some arrangements, the light emitted from the surface 112 of the electronic device 11 may be directly coupled to the optical component 13 or coupled to the optical component 13 through a medium component or a device, such as an adhesive material, an optical fiber, a grating coupler, and a beam inverter. For example, the optical component 13 may be attached to the electronic device 11 through an adhesive material 60. The adhesive material 60 may include or may be of the same material as the optical component 13 or an index-matching material, which reduces the difference in refraction index (for the bandwidths of the electronic device 11) between the electronic device 11 and the optical component 13. The adhesive material 60 may be transparent to the light emitted from the light emitting region of the electronic device 11. In some arrangements, a width of the adhesive material 60 may be greater than a width of the light emitting region of the electronic device 11. In some arrangements, the adhesive material 60 can prevent the light block issue due to the encapsulant 15 bleeding between the electronic device 11 and the optical component 13.

In some arrangements, the light emitting surface of the electronic device 11 may face the carrier 10 to prevent the light emitting surface from being covered by the encapsulant 15.

The electronic device 12 may be disposed over or on the surface 102 of the carrier 10. The electronic device 12 may be electrically connected to the carrier 10 through solder bonding, Cu-to-Cu bonding, wire bonding, or hybrid bonding. For example, the electronic device 12 may be electrically connected to the carrier 10 through an electrical contact 12s. In some arrangements, the electrical contacts 12s may be covered by an underfill 12u. The electronic device 12 may be disposed laterally with respect to the electronic device 11.

The electronic device 12 (or electronic component) may include an optical component, such as a photo-detector, a photo-sensor, a photodiode (PD), a charge-coupled device (CCD), a photomultiplier tube, a camera, a spectrometer, or another light-sensitive electronic device. In some arrangements, the electronic device 12 may be configured to control the electronic device 11. For example, the electronic device 12 may include a driver integrated circuit (IC) that provides brightness control and/or color control of the electronic device 11.

The electronic device 12 may be configured to receive light (or EM radiation in the ultraviolet, visible, and/or infrared spectral regions) and generate electrical signals (e.g., an electrical current). For example, the electronic device 12 may convert light energy in the form of photons to an electric current. The electrical signals may be related to one or more properties of the light, such as luminous flux (or luminous power or brightness), luminous intensity, propagation direction, wavelength (or frequency, or bandwidth), polarization state, etc. In some arrangements, the electronic device 12 may be configured to control the electronic device 11 based on the one or more properties of the light.

The electronic device 12 may include a surface 121 facing the carrier 10 and a surface 122 opposite to the surface 121 and facing away from the carrier 10. The surface 122 may include an active surface, an active region, or a light receiving region. For example, the electronic device may include light receiving regions 12a1 and 12a2 in proximity to, adjacent to, or embedded in and exposed by the surface 122. The light receiving regions 12a1 and 12a2 may include receivers, such as optical receivers. Light may be received by the light receiving regions 12a1 and 12a2. The surface 121 may include a backside surface.

In some arrangements, the light receiving region 12a1 may be configured to receive a proportion or percentage of the light emitted from the surface 112 of the electronic device 11. For example, a proportion or percentage of the light emitted from the surface 112 of the electronic device 11 may be guided toward the light receiving region 12a1 by the optical component 13. In some arrangements, the electronic device 12 may transmit the electrical signals to a controller (not shown) to control or monitor the electronic device 11 based on the one or more properties of the light received by the light receiving region 12a1. The controller may include a processor, computing system (e.g., an ASIC or FPGA), or other suitable circuitry configured to analyze one or more characteristics of electrical signals from the electronic device 12. In some arrangements, the electronic device 12 may include a through via electrically connected with the light receiving region 12a1 and the carrier 10.

For example, a threshold value (or a desired value) for the one or more properties of the light may be predetermined. If the electrical signals from the electronic device 12 indicate that the one or more properties exceed the threshold value, the controller may generate logic or instructions to adjust or to calibrate (such as to decrease) the one or more properties of the light.

Additionally, if the electrical signals from the electronic device 12 indicate that the one or more properties of the light are too low (or lower than an acceptable value), the controller may generate logic or instructions to adjust (such as to increase) the one or more properties of the light. In some arrangements, the controller may generate logic or instructions to adjust or to calibrate the electrical current or voltage provided to the electronic device 11, thereby monitoring and controlling the one or more properties of the light.

The light received by the light receiving region 12a1 can be used as a reference light (or a reference signal) to monitor the light emitted from the surface 112 of the electronic device 11. The light emitted from the surface 112 of the electronic device 11 can be adjusted according to the reference light at the appropriate time, promptly, or immediately. The one or more properties of the light emitted from the surface 112 of the electronic device 11 can be controlled and kept within a predetermined range.

In some arrangements, the light receiving region 12a2 may be configured to receive external light, ambient light, reflected light, or light from a light source outside of the optical module 1a. For example, a proportion or percentage of the light emitted from the surface 112 of the electronic device 11 may pass through the optical components 13 and may be received by (or may radiate) an object. The object may include any suitable object that is moving or stationary relative to the optical module 1a. The object may scatter or reflect at least a portion of the light, and the scattered or reflected light may return toward the optical module 1a and be received by the light receiving region 12a2.

In some arrangements, the electronic device 12 may transmit the electrical signals to a controller (not shown) to determine one or more characteristics of the object, such as its distance downrange from the optical module 1a. This can be done, for example, by analyzing the time of flight or phase modulation for the light emitted from the electronic device 11.

The optical component 13 may be attached to the electronic device 12 through an adhesive material 61. The adhesive material 61 may include or may be of the same material as the optical component 13 or an index-matching material, which reduces the difference in refraction index (for the bandwidths of the electronic device 12) between the electronic device 12 and the optical component 13. The adhesive material 61 may be transparent to the light received by the light receiving region 12a1. In some arrangements, a width of the adhesive material 61 may be greater than a width of the light receiving region 12a1. In some arrangements, the adhesive material 61 can prevent the light block issue due to the encapsulant 15 bleeding between the electronic device 12 and the optical component 13.

The optical component 14 may be attached to the electronic device 12 through an adhesive material 62. The adhesive material 62 may include or may be of the same material as the optical component 14 or an index-matching material, which reduces the difference in refraction index (for the bandwidths of the electronic device 12) between the electronic device 12 and the optical component 14. The adhesive material 62 may be transparent to the light received by the light receiving region 12a2. In some arrangements, a width of the adhesive material 62 may be greater than a width of the light receiving region 12a2. In some arrangements, the adhesive material 62 can prevent the light block issue due to the encapsulant 15 bleeding between the electronic device 12 and the optical component 14. The adhesive material 60 and the adhesive material 61 may be configured to fix the location of the optical component 13. The adhesive material 60 and the adhesive material 61 may be configured to adjust an elevation of the optical component 13 with respect to the electronic device 12 and the electronic device 11. The adhesive material 60 and the adhesive material 61 may be configured to adjust a level or a horizontal surface with respect to the electronic device 12 and the electronic device 11. In some arrangements, a top surface of the adhesive material 60 and a top surface of the adhesive material 61 may be substantially aligned. In some arrangements, a top surface of the adhesive material 60, a top surface of the adhesive material 61, and a top surface of the adhesive material 62 may be substantially aligned.

The optical component 13 may be disposed over or on the surface 112 of the electronic device 11 and the surface 122 of the electronic device 12. The optical component 13 may cover the light emitting region (such as the surface 112) of the electronic device 11 and the light receiving region 12a1 of the electronic device 12. In some arrangements, the optical component 13 may contact (such as directly contact) the light emitting region (such as the surface 112) of the electronic device 11 and the light receiving region 12a1 of the electronic device 12.

The optical component 13 may be transmissive to the light emitted from the electronic device 11. The optical component 13 may include a light transmissive material, such as clear glass, clear plastic, clear gel, clear resin, clear epoxy, sapphire, or other transparent materials. In some arrangements, the optical component 13 may include a panel, a waveguide, a prism, a concave lens, a convex lens, a flat surface, a diffuser, a shutter, a filter, a holographic element, or another transparent element. In some arrangements, the optical component 13 may include or may be a glass portion of a cell phone, a tablet, a notebook, a camera, or other electronic devices equipped with a proximity sensor.

In some arrangements, the optical component 13 may include a surface 131 facing the carrier 10 and a surface 132 opposite to the surface 131 and facing away from the carrier 10. In some arrangements, the optical component 13 may include an overhang disposed over the electronic device 11. The optical component 13 may extend between the light emitting region (such as the surface 112) of the electronic device 11 and the light receiving region 12a1 of the electronic device 12. The optical component 13 may exceed a lateral surface of the electronic device 12. The electronic device 11 may be disposed under a vertical projection of the overhang of the optical component 13.

In some arrangements, the optical component 13 may be configured to provide an optical guiding path within the optical module 1. In some arrangements, the optical component 13 may be configured to provide internal light transmission/reception paths. For example, the optical component 13 may be configured to guide a propagation of the light from the surface 112 of the electronic device 11 toward the light receiving region 12al.

A light blocking layer 13b may be disposed over or on the optical component 13. The light blocking layer 13b may be conformal to one or more external surfaces of the optical component 13. The light blocking layer 13b may be disposed along the outline or contour of the optical component 13. In some arrangements, the surface 131 of the optical component 13 may be at least partially exposed by (or uncovered by) the light blocking layer 13b.

The light blocking layer 13b may be non-transmissive to the light emitted from the electronic device 11. In some arrangements, the light blocking layer 13b may be configured to block, reflect, scatter, or absorb light emitted from the electronic device 11. In some arrangements, the light blocking layer 13b may be configured to prevent undesired light (e.g., light from an external environment) from being inadvertently detected by the light receiving region 12a1 of the electronic device 12. In some arrangements, the light blocking layer 13b may be configured to reflected or scattered a proportion or percentage of the light emitted from the surface 112 of the electronic device 11 toward the light receiving region 12a1 of the electronic device 12.

In some arrangements, the light blocking layer 13b may have an adequate optical density or opacity, which may depend on the light being considered. In some arrangements, the light blocking layer 13b may be configured to transmit almost no light, and therefore reflect, scatter, or absorb all of it. The light blocking layer 13b includes an opaque material, such as ink, carbon black, photoresist, a metal layer, or other non-transparent materials. In some arrangements, a thickness of the light blocking layer 13b may be about 10 μm or more.

The light blocking layer 13b may define an aperture (such as the aperture 13a in FIG. 1B) through which light can pass. The aperture (such as the aperture 13a in FIG. 1B) may expose the optical component 13 from the encapsulant 15 and may be configured to define a light transmission path. In some arrangements, a width of the aperture may be greater than a width traversing an emission cone of the electronic device 11 at an elevation leveled with the aperture.

The light blocking layer 13b may have a protruding portion 13p constituting a sidewall of the aperture. The location of the aperture may correspond to the light emitting region (which may be disposed over the surface 112) of the electronic device 11. In some arrangements, the aperture and the light receiving region 12a1 may be vertically misaligned. The aperture may be filled with a light transmissive material 13t. The protruding portion 13p of the light blocking layer 13b may surround the light transmissive material 13t.

A top surface of the light transmissive material 13t may be exposed from the encapsulant 15. The top surface of the light transmissive material 13t may recess from the top surface of the protruding portion 13p of the light blocking layer 13b. The top surface of the protruding portion 13p of the light blocking layer 13b may be higher than the top surface of the light transmissive material 13t.

The light transmissive material 13t and the light emitting region (which may be disposed over the surface 112) of the electronic device 11 may at least partially overlap substantially perpendicular to the surface 102 of the carrier 10. In some arrangements, a proportion or percentage of the light emitted from the surface 112 of the electronic device 11 may pass through the light transmissive material 13t. The light transmissive material 13t may include a light transmissive material, such as clear glass, clear plastic, clear gel, clear resin, clear epoxy, sapphire, or other transparent materials. The light transmissive material 13t may be thermally and/or optically cured. The light transmissive material 13t may include the same material as the optical component 13. In some arrangements, a thickness of the light transmissive material 13t may be about 50 μm or more.

In some arrangements, the optical component 13 may be preconstructed or pre-formed before being attached to the electronic device 11 and the electronic device 12. For example, the optical component 13 may be processed before being attached to the electronic device 11 and the electronic device 12. The processes may include forming a panel, a waveguide, a prism, a concave lens, a convex lens, a flat surface, a diffuser, a shutter, a filter, a holographic element, etc. The processes may include adjusting one or more properties of the optical component 13, such as a refractive index, a transmission coefficient, resilience to magnetic field, etc. For example, the light blocking layer 13b and the light transmissive material 13t may be pre-formed over the optical component 13 before attaching the optical component 13 to the electronic device 11 and the electronic device 12.

The optical component 14 may be disposed over or on the surface 122 of the electronic device 12. The optical component 14 may cover the light receiving region 12a2 of the electronic device 12. In some arrangements, the optical component 14 may contact (such as directly contact) the light receiving region 12a2 of the electronic device 12. In some arrangements, the optical component 14 may include a surface 141 facing the carrier 10 and a surface 142 opposite to the surface 141 and facing away from the carrier 10.

In some arrangements, the optical component 14 may be configured to guide a light external to the optical module 1 to enter the light receiving region 12a2 of the electronic device 12. In some arrangements, the optical component 14 may be configured to guide external light, reflected light, or light from a light source outside of the optical module 1a toward the light receiving region 12a2 of the electronic device 12. The optical component 14 may be similar to the optical component 13 and a description thereof is not repeated hereinafter for conciseness.

A light blocking layer 14b may be disposed over or on the optical component 14. The light blocking layer 14b may be conformal to one or more external surfaces of the optical component 14. The light blocking layer 14b may be disposed along the outline or contour of the optical component 14. In some arrangements, the surface 141 of the optical component 14 may be at least partially exposed by (or uncovered by) the light blocking layer 14b.

In some arrangements, the light blocking layer 14b may be configured to prevent undesired light (e.g., light from an external environment) from being inadvertently detected by the light receiving region 12a2 of the electronic device 12. The light blocking layer 14b may be similar to the light blocking layer 13b and a description thereof is not repeated hereinafter for conciseness.

The light blocking layer 14b may define an aperture (such as the aperture 14a in FIG. 1B) through which light can pass. The aperture (such as the aperture 14a in FIG. 1B) may be configured to define a light reception path. A width of the aperture may be smaller than a width of the light receiving region 12a2 of the electronic device 12.

The light blocking layer 14b may have a protruding portion 14p constituting a sidewall of the aperture. The location of the aperture may vertically correspond to the light receiving region 12a2 of the electronic device 12. The aperture may be filled with a light transmissive material 14t. The protruding portion 14p of the light blocking layer 14b may surround the light transmissive material 14t.

The light transmissive material 14t and the light receiving region 12a2 of the electronic device 12 may at least partially overlap substantially perpendicular to the surface 102 of the carrier 10. In some arrangements, external light, reflected light, or light from a light source outside of the optical module 1a may pass through the light transmissive material 14t and received by the light receiving region 12a2. The light transmissive material 14t may be similar to the light transmissive material 13t and a description thereof is not repeated hereinafter for conciseness.

In some arrangements, a part of the light blocking layer 13b and a part of the light blocking layer 14b may be disposed between the optical component 13 and the optical component 14.

The encapsulant 15 may be disposed over or on the carrier 10 to cover the optical components 13 and 14. A part of the encapsulant 15 may be disposed between the optical components 13 and 14. The encapsulant 15 may contact the surface 102 of the carrier 10. The encapsulant 15 may contact or surround the electronic devices 11 and 12. Apart of the encapsulant 15 may be disposed between the electronic devices 11 and 12. A part of the encapsulant 15 may be disposed between the electronic device 12 and the optical component 13. A part of the encapsulant 15 may be disposed between the electronic device 12 and the optical component 14. The optical component 13 may be partially supported by the encapsulant 15. The surface 131 of the optical component 13 may contact the encapsulant 15. The surface 131 of the optical component 13 may be covered by the encapsulant 15. In some arrangements, the encapsulant 15 may fix the optical component 13. The optical component 13 may be locked in the encapsulant 15.

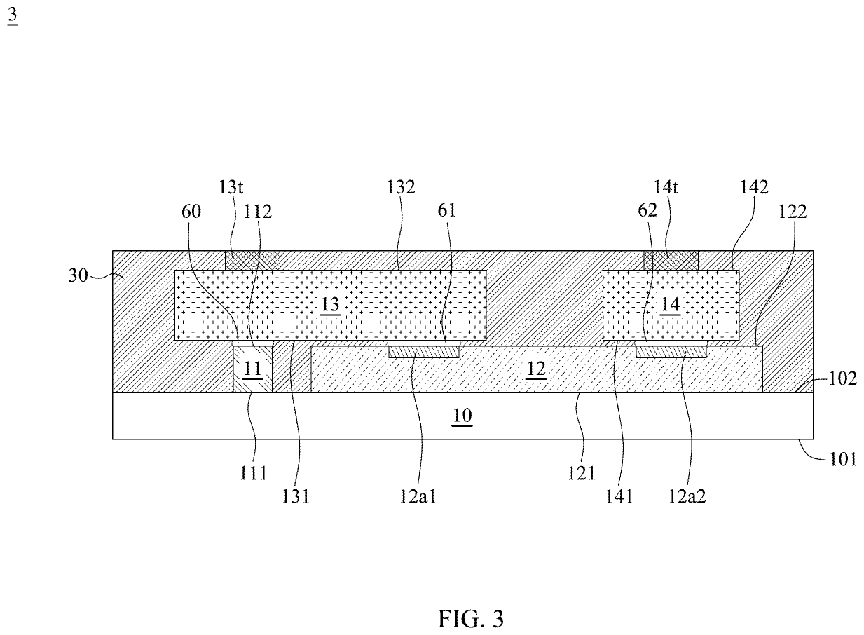

The light transmissive material 13t and the light transmissive material 14t may each be at least partially exposed by the encapsulant 15. The encapsulant 15 may include a light transmissive material, such as clear glass, clear plastic, clear gel, clear resin, clear epoxy, sapphire, or other transparent materials. The encapsulant 15 may include the same material as the optical component 13 or the optical component 14. In some arrangements, the encapsulant 15 may include a light blocking layer. For example, as shown in FIG. 3, the encapsulant 30 may include an opaque material. In some arrangements, the opaque material may be an opaque epoxy (e.g., a black epoxy) or other opaque resin or polymer. In some arrangements, a refractive index of the encapsulant 15 may be less than a refractive index of the light blocking layer 13b.

In a comparative embodiment, a lid may be used to define an aperture for light transmission/reception paths and prevent unwanted optical noise or interference. The lid may occupy a certain surface area and a glass may be needed, which may be disadvantageous to size conservation. According to some arrangements of the present disclosure, by replacing the encapsulant 15 with the lid, and using the optical components 13 and 14 and the light blocking layers 13b and 14b to define light transmission/reception paths, the package size of the optical module 1a can be minimized. In addition, using the light blocking layers 13b and 14b to define apertures, the size of the apertures can be scaled down to prevent undesired light being detected and thus increase the accuracy of the optical module 1a.

FIG. 1B is a cross-section of an exemplary optical module 1b according to some arrangements of the present disclosure. The optical module 1b is similar to the optical module 1a in FIG. 1A except that the apertures 13a and 14a may include air-filled physical apertures.

In some arrangements, the light transmissive materials 13t and 14t in FIG. 1A may be at least partially removed. In some arrangements, the light transmissive materials 13t and 14t in FIG. 1A may be entirely removed to form the apertures 13a and 14a in FIG. 1B.

Atop surface 13b1 of the protruding portion 13p of the light blocking layer 13b may be exposed from the encapsulant 15. In some arrangements, a surface roughness or a roughness (such as Ra and/or Rz) of the top surface 13b1 of the protruding portion 13p may be different from a surface roughness of a portion other than the light blocking layer 13b.

For example, a surface roughness of the light blocking layer 13b proximal to the aperture is different from a surface roughness of the light blocking layer 13b away from the aperture. For example, a surface roughness of the top surface 13b1 of the protruding portion 13p may be substantially greater than a surface roughness of a portion other than the light blocking layer 13b. During a manufacturing process of the optical module 1b according to some arrangements of the present disclosure, the light blocking layer 13b may be partially or entirely removed to form the top surface 13b1 of the protruding portion 13p exposed from the encapsulant 15.

FIG. 1C is a cross-section of an exemplary optical module 1c according to some arrangements of the present disclosure. The optical module 1c is similar to the optical module 1a in FIG. 1A except that the adhesive materials 61 and/or 62 may bleed and may exist between the optical component 13 and the optical component 14.

FIG. 1D is a perspective view of an exemplary optical module according to some arrangements of the present disclosure. FIG. 1E is a top view of an exemplary optical module according to some arrangements of the present disclosure. Some elements in FIG. 1D and FIG. 1E are omitted for conciseness. The optical modules of the present disclosure may have a perspective view and a top view in FIG. 1D and FIG. 1E.

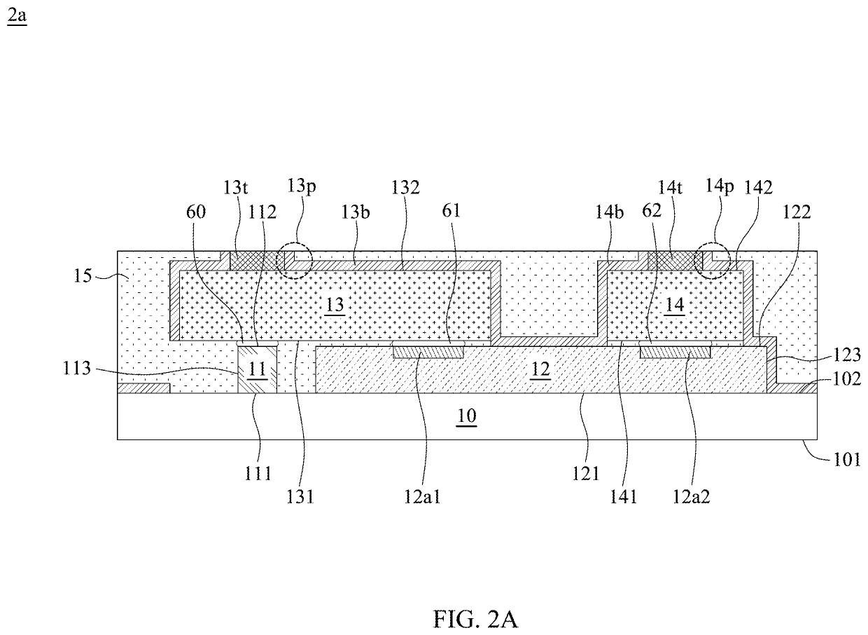

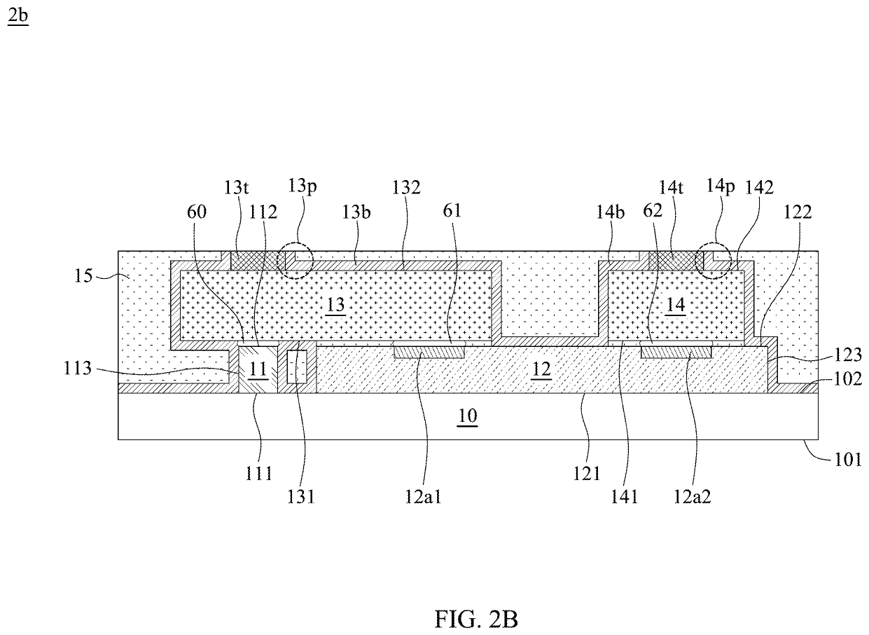

FIG. 2A is a cross-section of an exemplary optical module 2a according to some arrangements of the present disclosure. The optical module 2a is similar to the optical module 1a in FIG. 1A except that the light blocking layer 13b is disposed over the surface 102 of the carrier 10, the surface 122 of the electronic device 12, and the lateral surfaces 123 (which may extend between the surfaces 121 and 122) of the electronic device 12.

FIG. 2B is a cross-section of an exemplary optical module 2b according to some arrangements of the present disclosure. The optical module 2b is similar to the optical module 2a in FIG. 2A except that the light blocking layer 13b is also disposed over the lateral surfaces 113 (which may extend between the surfaces 111 and 112) of the electronic device 11 and the surface 131 of the optical component 13.

FIG. 3 is a cross-section of an exemplary optical module 3 according to some arrangements of the present disclosure. The optical module 3 is similar to the optical module 1a in FIG. 1A except that the encapsulant 30 may include an opaque material. In some arrangements, the opaque material may be an opaque epoxy (e.g., a black epoxy) or other opaque resin or polymer.

In some arrangements, a refractive index of the encapsulant 30 may be equal to or greater than a refractive index of the blocking layer 13b and the light blocking layer 14b in FIG. 1A. In some arrangements, the light blocking layer 13b and the light blocking layer 14b in FIG. 1A may be omitted. The encapsulant 30 may block the light from the electronic device 11. The encapsulant 30 may be disposed over or on the optical component 13 to define an aperture (such as the aperture 13a in FIG. 1B) through which light can pass. The aperture may be filled with the light transmissive material 13t. In some arrangements, the aperture may include an air-filled physical aperture.

Similarly, the encapsulant 30 may be disposed over or on the optical component 14 to define an aperture (such as the aperture 14a in FIG. 1B) through which light can pass. The aperture may be filled with the light transmissive material 14t. In some arrangements, the aperture may include an air-filled physical aperture.

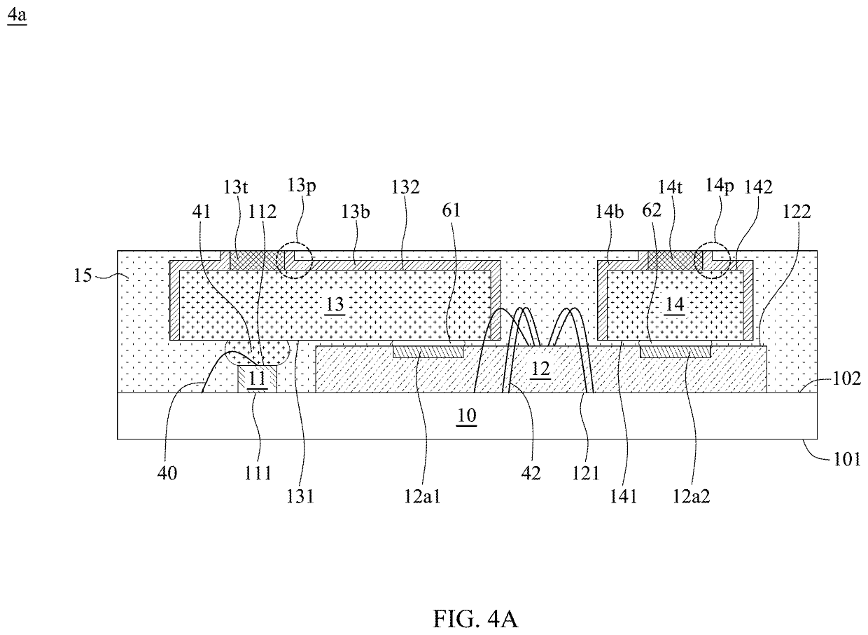

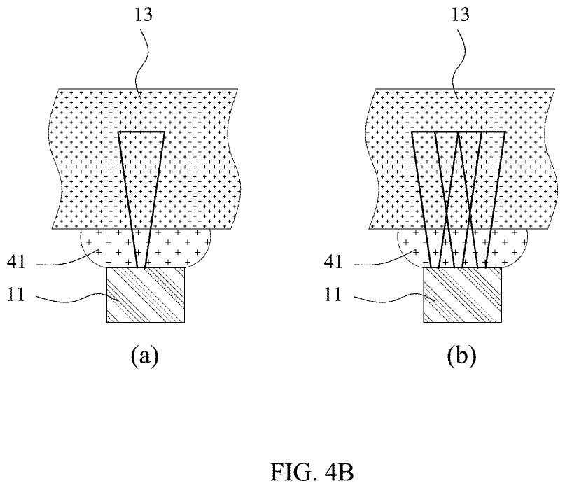

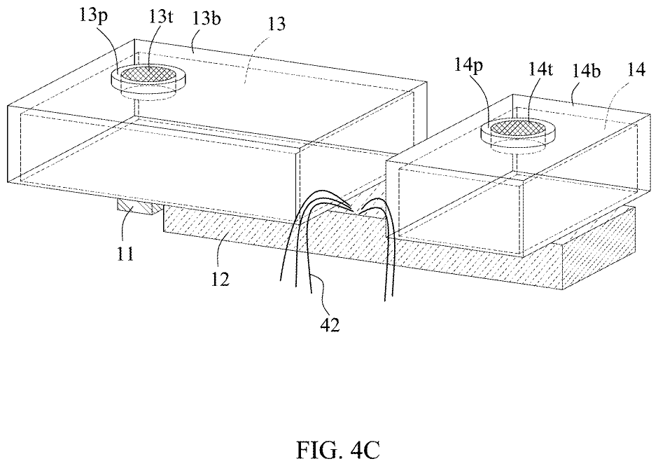

FIG. 4A is a cross-section of an exemplary optical module 4a according to some arrangements of the present disclosure. The optical module 4a is similar to the optical module 1a in FIG. 1A with differences therebetween as follows.

The electronic device 11 may be electrically connected to the surface 102 of the carrier 10 through a conductive wire 40. The conductive wire 40 may contact or connect to the light emitting region (such as the surface 112) of the electronic device 11. The conductive wire 40 may extend from the light emitting region (such as the surface 112) of the electronic device 11 to the surface 102 of the carrier 10.

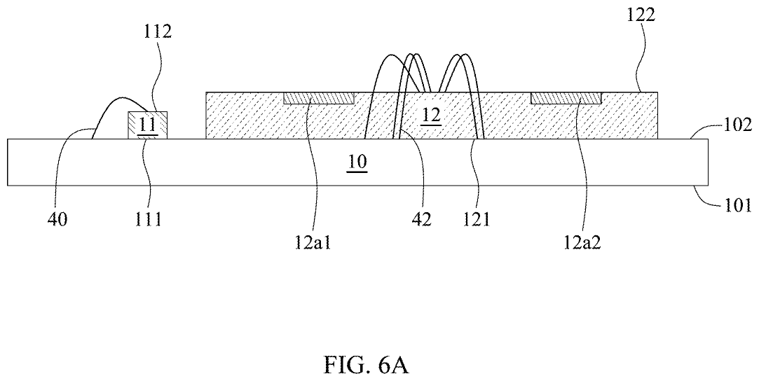

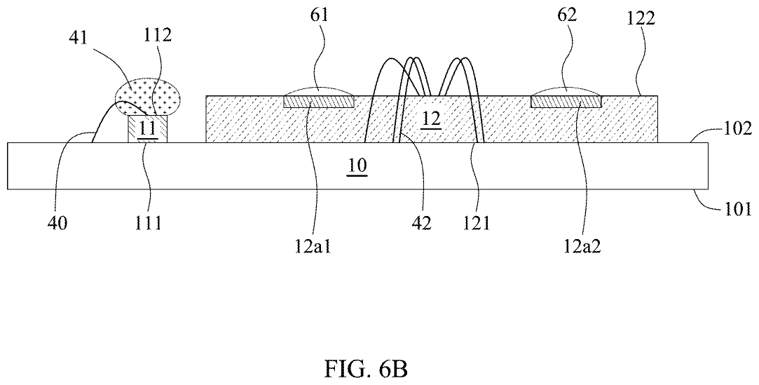

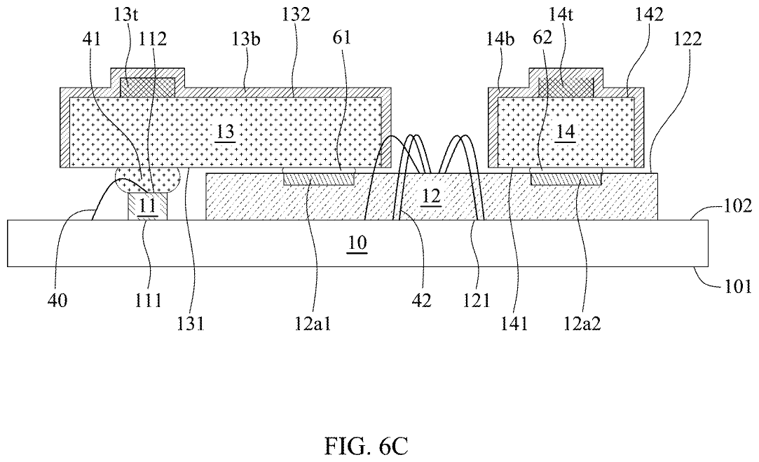

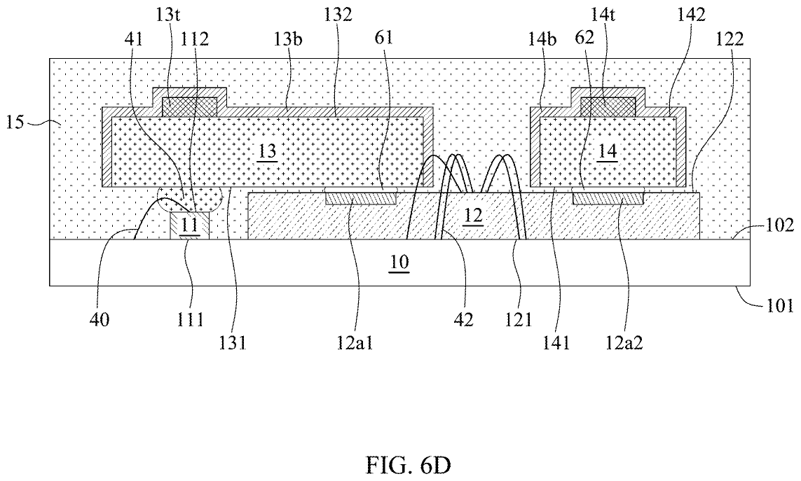

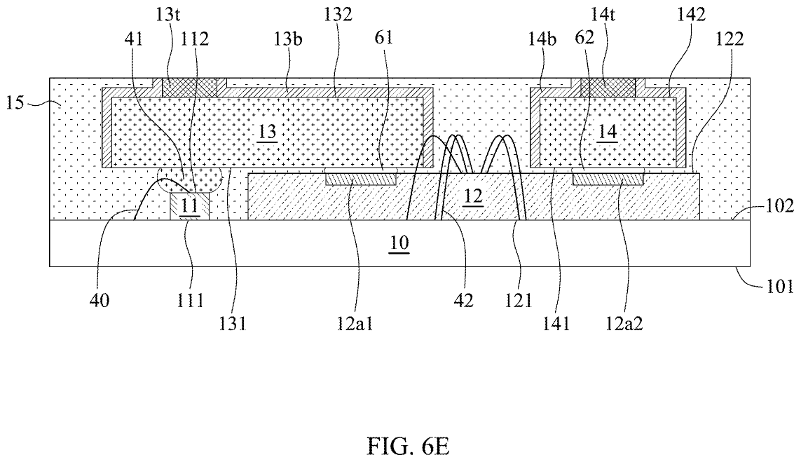

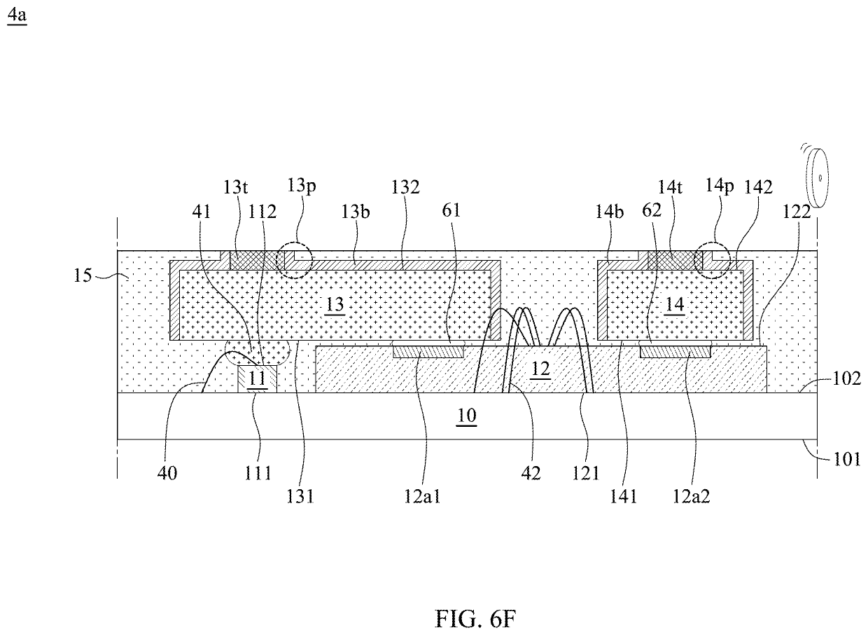

An adhesive material 41 may be disposed over or on the light emitting region (such as the surface 112) of the electronic device 11 to cover a part of the conductive wire 40. The adhesive material 41 may include or may be of the same material as the optical component 13 or an index-matching material, which reduces the difference in refraction index (for the bandwidths of the electronic device 11) between the electronic device 11 and the optical component 13. The adhesive material 41 may be transparent to the light from the electronic device 11. The adhesive material 41 may be identical to the adhesive material 60 and/or the adhesive material 61 in FIG. 6B.

In some arrangements, the adhesive material 41 may be configured to prevent the light from the electronic device 11 from being blocked by the encapsulant 15. For example, as shown in the enlarged view in FIG. 4B, the light beams from one or more emitting regions of the electronic device 11 may be covered by the adhesive material 41. The encapsulant 15 may be spaced apart from the one or more emitting regions of the electronic device 11.

In some arrangements, the adhesive material 41 may be configured to support the optical component 13. In some arrangements, the adhesive material 41 may be configured to compensate a thickness difference between the electronic device 11 and the electronic device 12.

In some arrangements, a shape of the adhesive material 41 may be configured to enhance light collection from the electronic device 11. For example, the adhesive material 41 may have a bowl shape. For example, a width of the adhesive material 41 at an elevation contacting the optical component 13 is greater than a width of an emitting region of the electronic device 11.

In some arrangements, the encapsulant 15 may include an opaque material. The adhesive material 41 and the encapsulant 15 may collaboratively define a lens or a reflective cup.

The electronic device 12 may be electrically connected to the surface 102 of the carrier 10 through a conductive wire 42. The conductive wire 42 may contact or connect to the surface 122 of the electronic device 12. The conductive wire 42 may extend from the surface 122 of the electronic device 12 to the surface 102 of the carrier 10. The conductive wire 42 may be disposed between the optical component 13 and the optical component 14.

FIG. 4C is a perspective view of an exemplary optical module according to some arrangements of the present disclosure. Some elements in FIG. 4C are omitted for conciseness. The optical module 4a may have a perspective view in FIG. 4C.

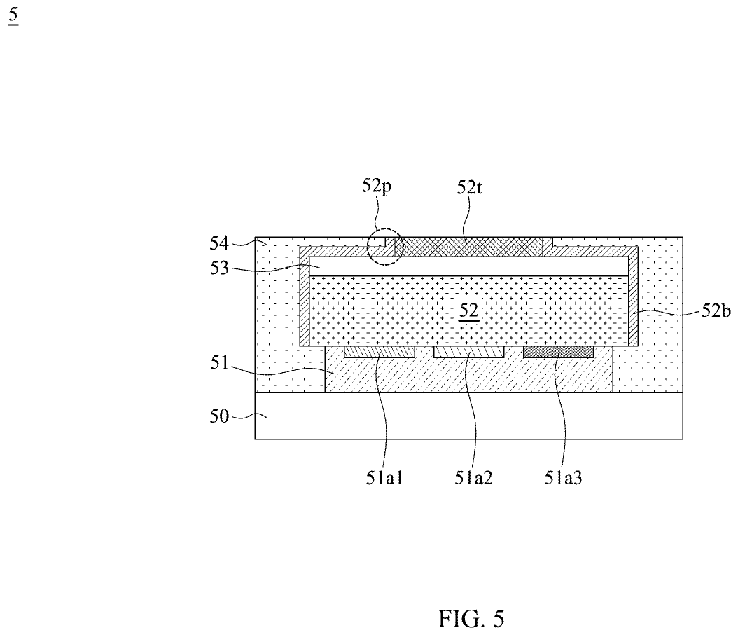

FIG. 5 is a cross-section of an exemplary optical module 5 according to some arrangements of the present disclosure. The optical module 5 is similar to the optical module 1a in FIG. 1A with differences therebetween as follows.

The optical module 5 may include a carrier 50, an electronic device 51, optical components 52, 53, and an encapsulant 54.

The carrier 50 may be similar to the carrier 10 and a description thereof is not repeated hereinafter for conciseness. The electronic device 51 may be disposed over or on the carrier 50. The electronic device 51 may be electrically connected to the carrier 50 through solder bonding, Cu-to-Cu bonding, wire bonding, or hybrid bonding.

The electronic device 51 may include a photo-detector, a photo-sensor, a PD, a CCD, a photomultiplier tube, a camera, a spectrometer, or another light-sensitive electronic device. The electronic device 51 may include light receiving regions 51a1, 51a2, and 51a3. The light receiving regions 51a1, 51a2, and 51a3 may be configured to receive visible light of different wavelengths (or frequencies, or bandwidths), such as red, blue, and green light.

The optical component 52 may be disposed over or on the light receiving regions 51a1, 51a2, and 51a3. The optical component 52 may be similar to the optical component 13 and a description thereof is not repeated hereinafter for conciseness.

The optical component 53 may be disposed over or on the optical component 52. The optical component 53 may include a panel, a waveguide, a prism, a concave lens, a convex lens, a flat surface, a diffuser, a shutter, a filter, a holographic element, etc.

A light blocking layer 52b may be disposed over or on the optical components 52 and 53. The light blocking layer 52b may be conformal to one or more external surfaces of the optical components 52 and 53. The light blocking layer 52b may be disposed along the outline or contour of the optical components 52 and 53. In some arrangements, a surface of the optical component 52 may be at least partially exposed by (or uncovered by) the light blocking layer 52b.

In some arrangements, the light blocking layer 52b may be configured to prevent undesired light (e.g., light from an external environment) from being inadvertently detected by the light receiving regions 51a1, 51a2, and 51a3 of the electronic device 51. The light blocking layer 52b may be similar to the light blocking layer 13b and a description thereof is not repeated hereinafter for conciseness.

The light blocking layer 52b may define an aperture through which light can pass. The aperture may be configured to define a light reception path. The light blocking layer 52b may have a protruding portion 52p constituting a sidewall of the aperture. The location of the aperture may correspond to the light receiving regions 51a1, 51a2, and 51a3 of the electronic device 51. The aperture may be filled with a light transmissive material 52t. The protruding portion 52p of the light blocking layer 52b may surround the light transmissive material 52t.

FIGS. 6A, 6B, 6C, 6D, 6E, and 6F are cross-sections of one or more stages of a method of manufacturing an optical module in accordance with an arrangement of the present disclosure. In some arrangements, the optical module 4a may be manufactured through the operations described with respect to FIGS. 6A, 6B, 6C, 6D, 6E, and 6F.

Referring to FIG. 6A, the electronic devices 11 and 12 may be disposed over or on the surface 102 of the carrier 10. An active surface, an active region, or a light emitting region (such as the surface 112) of the electronic device 11 may face away from the carrier 10. The light receiving regions 12a1 and 12a2 may be in proximity to, adjacent to, or embedded in and exposed by the surface 122 of the electronic device 12.

Referring to FIG. 6B, the adhesive material 41 may be disposed or dispensed over or on the light emitting region (such as the surface 112) of the electronic device 11. The adhesive material 61 may be disposed or dispensed over or on the light receiving region 12a1 the electronic device 12. The adhesive material 62 may be disposed or dispensed over or on the light receiving region 12a2 the electronic device 12.

Referring to FIG. 6C, the optical component 13 may be disposed over or on the surface 112 of the electronic device 11 and the surface 122 of the electronic device 12. The optical component 14 may be disposed over or on the surface 122 of the electronic device 12.

In some arrangements, the light transmissive material 13t and the light blocking layer 13b may be disposed over the optical component 13 before the optical component 13 is disposed over or on the electronic device 11 and the electronic device 12. Similarly, the light transmissive material 14t and the light blocking layer 14b may be disposed over the optical component 14 before the optical component 14 is disposed over or on the electronic device 12.

In some arrangements, the optical component 13 may be preconstructed or pre-formed before being attached to the electronic device 11 and the electronic device 12. For example, the optical component 13 may be processed before being attached to the electronic device 11 and the electronic device 12. The processes may include forming a panel, a waveguide, a prism, a concave lens, a convex lens, a flat surface, a diffuser, a shutter, a filter, a holographic element, etc. The processes may include adjusting one or more properties of the optical component 13, such as a refractive index, a transmission coefficient, resilience to magnetic field, etc. For example, the light blocking layer 13b and the light transmissive material 13t may be pre-formed over the optical component 13 before attaching the optical component 13 to the electronic device 11 and the electronic device 12.

In some arrangements, the light transmissive material 13t and the light transmissive material 14t may be thermally cured before attaching the optical component 13 to the electronic device 11 and the electronic device 12. In some arrangements, the light transmissive material 13t and the light transmissive material 14t may be thermally cured after attaching the optical component 13 to the electronic device 11 and the electronic device 12.

Referring to FIG. 6D, the encapsulant 15 may be disposed over or on the carrier 10 to cover the optical components 13 and 14. In some arrangements, the encapsulant 15 may be formed by molding, such as by printing, compressive molding, transfer molding, liquid encapsulant molding, vacuum lamination, spin coating, or other suitable processes.

Referring to FIG. 6E, a planarization operation or a grinding operation may be performed to remove a portion of the encapsulant 15 to expose the light transmissive materials 13t, 14t and the light blocking layers 13b and 14b. A part of each of the light transmissive materials 13t, 14t and the light blocking layers 13b and 14b may also be removed. The planarization operation or grinding operation may include an abrasive machining process that uses a grinding wheel or grinder, a chemical mechanical planarization (CMP) process, an etching process, or a laser direct ablation (LDA) process.

In some arrangements, a planarization operation or a grinding operation may be performed to remove at least a portion of the light transmissive materials 13t and 14t. In some arrangements, the light transmissive materials 13t and 14t in FIG. 6E may be entirely removed.

Referring to FIG. 6F, a singulation may be performed to separate out individual package devices. The singulation may be performed, for example, by using a dicing saw, laser or other appropriate cutting techniques. The structure obtained from the operation in FIG. 6F may be similar to the optical module 4a.

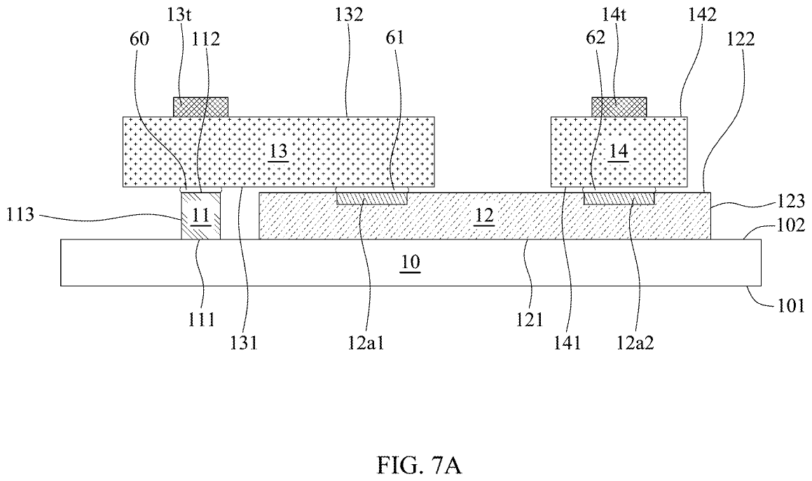

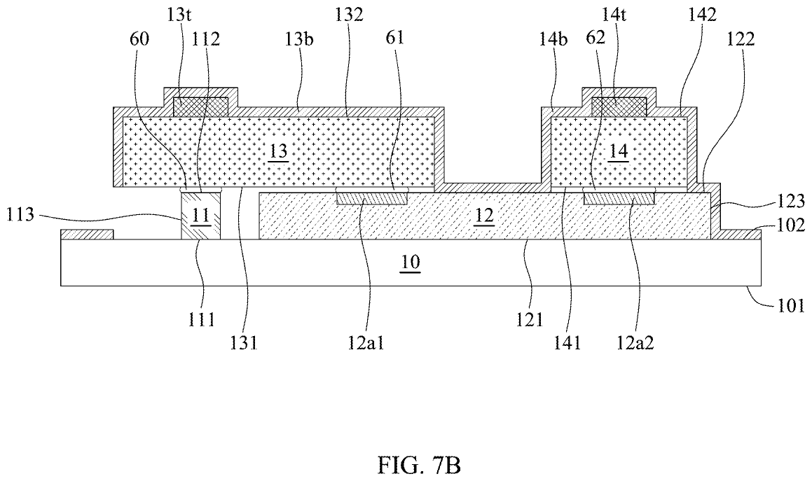

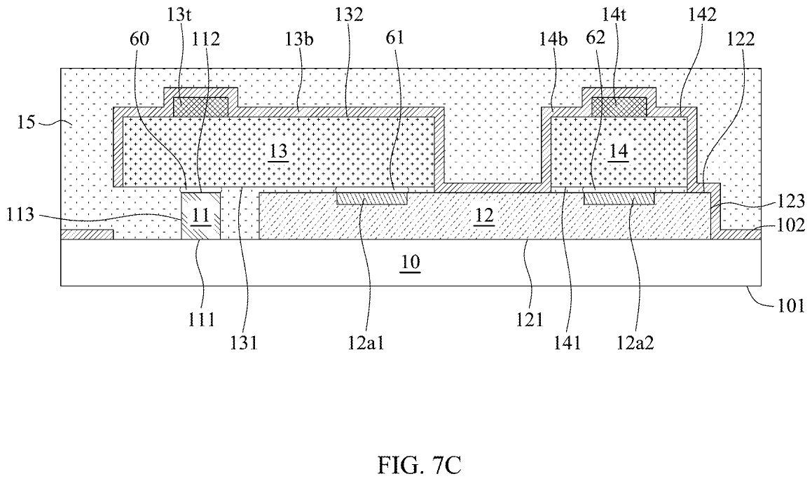

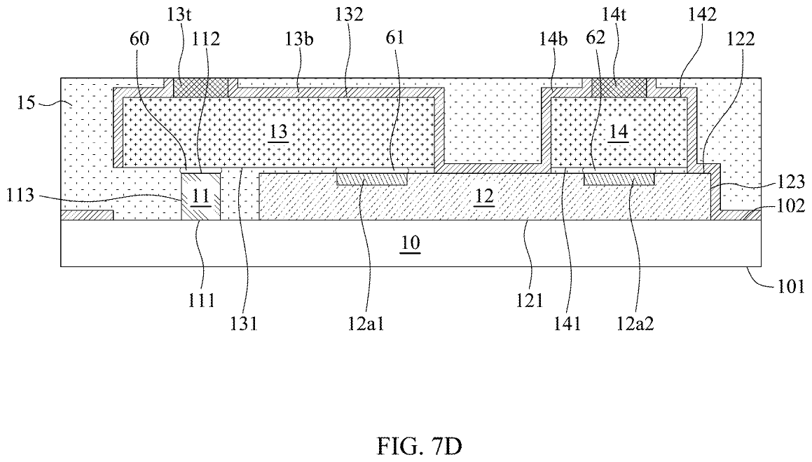

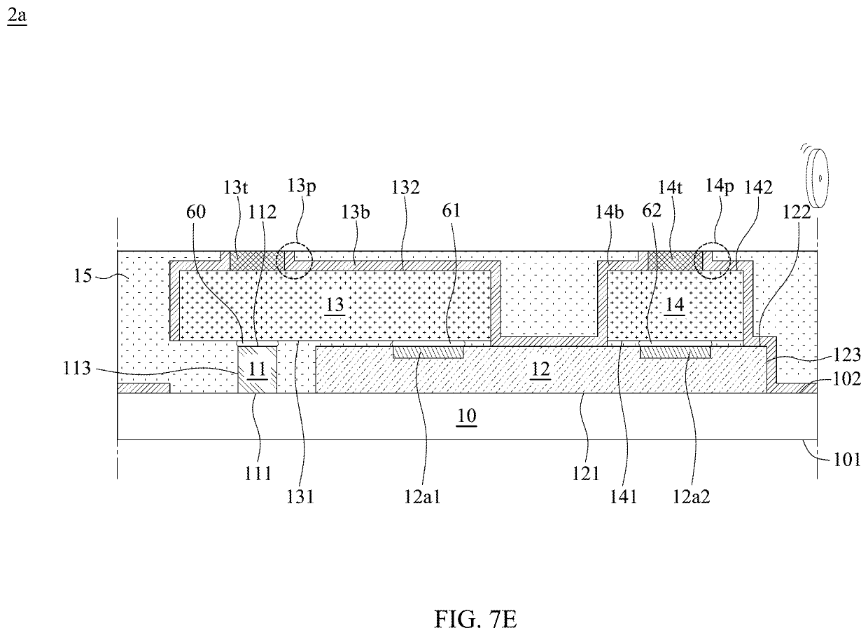

FIGS. 7A, 7B, 7C, 7D, and 7E are cross-sections of one or more stages of a method of manufacturing an optical module in accordance with an arrangement of the present disclosure. In some arrangements, the optical module 2a may be manufactured through the operations described with respect to FIGS. 7A, 7B, 7C, 7D, and 7E.

Referring to FIG. 7A, the operations in FIG. 7A may be subsequent to the operation in FIG. 6B. The optical component 13 may be disposed over or on the surface 112 of the electronic device 11 and the surface 122 of the electronic device 12. The optical component 14 may be disposed over or on the surface 122 of the electronic device 12.

In some arrangements, the light transmissive material 13t may be disposed over the optical component 13 before the optical component 13 is disposed over or on the electronic device 11 and the electronic device 12. Similarly, the light transmissive material 14t may be disposed over the optical component 14 before the optical component 14 is disposed over or on the electronic device 12.

In some arrangements, the light transmissive material 13t and the light transmissive material 14t may be thermally and/or optically cured.

Referring to FIG. 7B, the light blocking layer 13b may be disposed over the optical component 13 and the light blocking layer 14b may be disposed over the optical component 14. The light blocking layer 13b and the light blocking layer 14b may be formed through, for example, sputtering operations or spray coating operations.

Referring to FIG. 7C, the encapsulant 15 may be disposed over or on the carrier 10 to cover the optical components 13 and 14.

Referring to FIG. 7D, a planarization operation or a grinding operation may be performed to remove a portion of the encapsulant 15 to expose the light transmissive materials 13t, 14t and the light blocking layers 13b and 14b.

Referring to FIG. 7E, a singulation may be performed to separate out individual package devices. The structure obtained from the operation in FIG. 7E may be similar to the optical module 2a.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of arrangements of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Two surfaces can be deemed to be coplanar or substantially coplanar if a displacement between the two surfaces is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An optical module, comprising:
an emitter;
a receiver; and
a pre-formed transparent element disposed over the emitter and the receiver, configured to provide an optical guiding path within the optical module.

2. The optical module of claim 1, wherein the pre-formed transparent element is configured to guide a propagation of a light from the emitter toward the receiver.

3. The optical module of claim 2, wherein the receiver is a light receiving region of an electronic device, and the electronic device is configured to control the emitter.

4. The optical module of claim 1, further comprising:
an encapsulant covering a bottom surface of the pre-formed transparent element and at least partially disposed over the pre-formed transparent element.

5. The optical module of claim 4, further comprising:
a light blocking layer disposed between the encapsulant and the pre-formed transparent element, configured to reflect a light from the emitter.

6. The optical module of claim 1, further comprising:
a first adhesive material disposed between the emitter and the pre-formed transparent element, configured to support the pre-formed transparent element and compensate a thickness difference between the emitter and the receiver.

7. The optical module of claim 6, further comprising:
a second adhesive material disposed between the receiver and the pre-formed transparent element, wherein a top surface of the first adhesive material and a top surface of the second adhesive material are substantially aligned.

8. An optical module, comprising:
an electronic component;
a first transparent element disposed over the electronic component; and
a light blocking layer disposed over and conform to the first transparent element,
wherein a roughness of a top surface of the light blocking layer is greater than a roughness of another surface of the light blocking layer.

9. The optical module of claim 8, wherein the light blocking layer defines an aperture exposing the first transparent element from the light blocking layer.

10. The optical module of claim 9, wherein the top surface of the light blocking layer is around the aperture.

11. The optical module of claim 9, wherein the electronic component has a light receiving region, and wherein the light receiving region and the aperture are vertically misaligned.

12. The optical module of claim 8, further comprising:
a second transparent element disposed over the electronic component and separated from the first transparent element.

13. The optical module of claim 12, wherein a part of the light blocking layer is between the first transparent element and second transparent element.

14. The optical module of claim 12, further comprising:
a wire electrically connected to the electronic component, and at least partially disposed between the first transparent element and second transparent element in a cross-sectional view.

15. An optical module, comprising:
an optical component;
a transparent element disposed over the optical component; and
an adhesive material disposed between the optical component and the transparent element, wherein the adhesive material is transparent to a light emitting from or receiving by the optical component.

16. The optical module of claim 15, wherein a width of the adhesive material is greater than a width of a light emitting region or a light receiving region of the optical component.

17. The optical module of claim 16, wherein a shape of the adhesive material is configured to enhance light collection from the optical component.

18. The optical module of claim 15, wherein the adhesive material covers a conductive wire electrically connected to the optical component.

19. The optical module of claim 15, further comprising:
a light blocking layer encapsulating the optical component and the adhesive material.

20. The optical module of claim 19, wherein a part of the light blocking layer is between the optical component and the transparent element.
